(19) United States
(12) Patent Application Publication
(10) Pub. No.: US 2026/0109121 A1
(43) Pub. Date: Apr. 23, 2026

(54) ASPHERIC PRISM AND METHOD FOR MANUFACTURING SAME

(71) Applicant: AAC Optics (Chongqing) Co., Ltd., Chongqing (CN)

(72) Inventor: Linzhi Zhao, Chongqing (CN)

(21) Appl. No.: 19/001,363

(22) Filed: Dec. 24, 2024

Related U.S. Application Data
(63) Continuation of application No. PCT/CN2024/126600, filed on Oct. 23, 2024.

(51) Int. Cl. B29D 11/00; G02B 1/11; G02B 5/04

(52) U.S. Cl. CPC B29D 11/00932; B29D 11/0074; B29D 11/00865; G02B 1/11; G02B 5/04

(57) ABSTRACT

An aspheric prism and a method for manufacturing the same are provided. When processing, a wafer is formed by an integrated molding process. The wafer includes first prism bars. A first cutting process is performed on the wafer to enable that the first prism bars are separated from each other and each of the first prism bars is cut into two second prism bars. Each of the second prism bars includes one slope and one column of aspheric structures. A second cutting process is performed on each of the second prism bars to from initial prisms. An anti-reflection film is formed on a surface where an aspheric structure is located and an exit surface of each of the initial prisms. An ink coating operation is performed on each of the initial prisms to obtain the aspheric prism. The method improves manufacturing efficiency and structural accuracy of each aspheric prism.

### TECHNICAL FIELD

The present disclosure relates to a field of optical technology, and in particularly to an aspheric prism and a method for manufacturing the same.

### BACKGROUND

An aspheric prism is commonly composed of a lens (a convex lens or a concave lens) and a triangular prism.

In the related art, in a step of manufacturing the aspheric prism, the triangular prism is commonly assembled with the lens. Different assembly methods are adopted for different application scenarios. For example, the triangular prism and the lens bonded together by gluing. Alternatively, in a process of assembling an optical lens, a bracket is introduced to support the triangular prism and the lens for assembly. However, no matter which one of the assembly method is adopted, a matching gap between the triangular prism and the lens, a precision requirement of the aspheric prism, and an assembly precision requirements of the aspheric prism are very high.

Since the triangular prism and the lens are processed by different optical equipment, and processes of cutting, coating, and inking of the triangular prism and the lens are completed separately on different optical equipment, a manufacturing cycle of the aspheric prism is relatively long, manufacturing efficiency is low, and structural precision of different aspheric prisms is not unified.

Therefore, the manufacturing efficiency and the structural precision of the aspheric prism in the related art need to be improved.

### SUMMARY

Embodiments of the present disclosure provide an aspheric prism and a method for manufacturing the same, which at least improve manufacturing efficiency and structural precision of the aspheric prism.

In a first aspect, the present disclosure provides a method for manufacturing an aspheric prism. The method comprises:
forming a wafer by an integrated molding process, where the wafer comprises a first surface and a second surface opposite to the first surface, the wafer comprises first prism bars arranged in sequence along a first direction, each of the first prism bars comprises aspheric structures protruded with respect to the first surface of the wafer, the aspheric structures thereof are arranged in two columns in the first direction, the aspheric structures in each of the columns are arranged in sequence along a second direction, each of the first prism bars further comprises two slopes protruding with respect to the second surface of the wafer, and each of the slopes extends in the second direction;
performing a first cutting process on the wafer to enable that the first prism bars are separated from each other and each of the first prism bars is cut into two second prism bars, where each of the second prism bars comprises one slope of the slopes and one column of the columns of the aspheric structures arranged in sequence along the second direction, cutting surfaces of the first prism bars are configured as exit surfaces of the second prism bars; the second prism bars are formed by cutting the first prism bars from the cutting surfaces;
performing a second cutting process on each of the second prism bars to from initial prisms, where a cutting line of each of the second prism bars is located between adjacent aspheric structures, and each of the initial prisms comprises a corresponding exit surface, a corresponding aspheric structure, and a corresponding slope;
forming an anti-reflection film on a surface where the corresponding aspheric structure is located and the corresponding exit surface of each of the initial prisms; and performing an ink coating operation on surfaces other than the corresponding aspheric structure, the corresponding exit surface, and the corresponding slope of each of the initial prisms to obtain a corresponding aspheric prism

In one optional embodiment, the integrated molding process is a hot press molding process.

In one optional embodiment, each of the first prism bars is of an axisymmetric structure, and a cutting line of each of the first prism bars cutting into the two second prism bars thereof is a symmetry axis of each of the first prism bars.

In one optional embodiment, after performing the first cutting process, the method further comprises grinding and polishing each of the exit surfaces of the second prism bars to enable that an included angle between each of the exit surfaces of the second prism bars and the one slope of each of the second prism bars is 45°.

In one optional embodiment, the one slope of each of the second prism bars is a flat surface.

In one optional embodiment, before grinding each of the exit surfaces of the second prism bars, the method further comprises placing the one slope of each of the second prism bars on a workbench.

In one optional embodiment, after polishing each of the exit surfaces of the second prism bars, the method further comprises chamfering a corner of each of the second prism bars to form a chamfered surface of each of the second prism bars.

In one optional embodiment, a refractive index of a material of each of the initial prisms is not less than 1.75

In one optional embodiment, a refractive index of a material of each of the initial prisms is less than 1.75, and the method further comprises forming a high reflection film on the corresponding slope of each of the initial prisms.

In a second aspect, the present disclosure provides an aspheric prism. The aspheric prism is manufactured by the method according to any one of embodiments mentioned above.

The integrated molding process is adopted to form the wafer having the aspheric structures. The aspheric structures in the wafer are equivalent to lenses, and then the first cutting process, the second cutting process is performed on the wafer then anti-reflection film is formed, and finally the aspheric prism is obtained. In the related art, it is necessary to form an initial triangular prism and an initial lens, and then the initial triangular prism and the initial lens are cut, coated, and inked to form a triangular prism and a lens, and then the triangular prism and the lens are assembled to form an aspheric prism in the related art. Compared with the related art, the method for manufacturing the aspheric prism of the present disclosure shortens a manufacturing cycle of the aspheric prism and improves the processing efficiency. The method of the present disclosure adopts the integrated molding process to directly form the wafer having the aspheric structures and the slopes, thereby reducing a grinding process for preparing aspheric structures and slopes in the related art, and thus further shortening the manufacturing cycle and improving the processing efficiency. In addition, each of the first prism bars in the wafer prepared by the integrated molding process comprises the two slopes thereof and the two columns of the aspheric structures thereof. When performing the first cutting process, each of the first prism bars is cut to form the two second prism bars thereof having the one slope and the one column of the column of the aspheric structures. Compared with a method of grinding the wafer directly in the related art to form second prism bars in the related art, the method of the present disclosure improves a utilization rate of a material of the wafer, shortens the manufacturing cycle, and improves the processing efficiency. Moreover, the wafer is formed by the integrated molding process, and the aspheric prism finally obtained is of an integrated structure by subsequent processing processes on the wafer, so there is no assembly error of a triangular prism and a lens thereof, which improves structural accuracy of the aspheric prism.

### BRIEF DESCRIPTION OF DRAWINGS

One or more embodiments are exemplarily described by figures in the corresponding drawings. The drawings are for illustrative purpose only and do not constitute limitations on the embodiments unless otherwise stated. The figures in the drawings do not constitute proportional limitations. In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a front side schematic diagram of a wafer manufactured by an integrated molding process according to one embodiment of the present disclosure.

FIG. 2 is a bottom plan schematic diagram of the wafer manufactured by the integrated molding process according to one embodiment of the present disclosure.

FIG. 3 is a top plan schematic diagram of the wafer manufactured by the integrated molding process according to one embodiment of the present disclosure.

FIG. 4 is a side elevational schematic diagram of the wafer manufactured by the integrated molding process according to one embodiment of the present disclosure.

FIG. 5 is a perspective schematic diagram of the wafer manufactured by the integrated molding process according to one embodiment of the present disclosure.

FIG. 6 is a structural schematic diagram of a first prism bar cutting into two second prism bars according to one embodiment of the present disclosure.

FIG. 7 is a structural schematic diagram of one of the second prism bars according to one embodiment of the present disclosure.

FIG. 8 is a structural schematic diagram of the one of the second prism bars placed on a workbench according to one embodiment of the present disclosure.

FIG. 9 is a front side schematic diagram of the one of the second prism bars after a chamfering process according to one embodiment of the present disclosure.

FIG. 10 is a perspective schematic diagram of the one of the second prism bars after the chamfering process according to one embodiment of the present disclosure.

FIG. 11 is a perspective schematic diagram of an initial prism according to one embodiment of the present disclosure.

FIG. 12 is a side elevational schematic diagram of an aspheric prism according to one embodiment of the present disclosure.

FIG. 13 is a structural elevational schematic diagram of the aspheric prism according to one embodiment of the present disclosure.

### DETAILED DESCRIPTION

According to content of the background, it is noted that manufacturing efficiency and structural precision of an aspheric prism in the related art need to be improved.

The present disclosure provides a method for manufacturing an aspheric prism. An integrated molding process is adopted to form a wafer having aspheric structures, and then the wafer is processed to form the aspheric prism. The aspheric structures in the wafer are equivalent to lenses. In the related art, it is necessary to form an initial triangular prism and an initial lens, and then the initial triangular prism and the initial lens are cut, coated, and inked to form a triangular prism and a lens, and then the triangular prism and the lens are assembled to form an aspheric prism in the related art. Compared with the related art, the method for manufacturing the aspheric prism of the present disclosure shortens a manufacturing cycle of the aspheric prism and improves the processing efficiency. The method of the present disclosure adopts the integrated molding process to directly form the wafer having the aspheric structures and slopes, thereby reducing a grinding process for preparing aspheric structures and slopes in the related art, and thus further shortening the manufacturing cycle and improving the processing efficiency. In addition, when performing a first cutting process, each of the first prism bars is cut to form two second prism bars thereof having one slope and one column of the column of the aspheric structures, which omits a step of grinding the wafer directly in the related art to form second prism bars in the related art, so that the method of the present disclosure improves a utilization rate of a material of the wafer, shortens the manufacturing cycle, and improves the processing efficiency. Moreover, the wafer is formed by the integrated molding process, and the aspheric prism finally obtained is of an integrated structure by subsequent processing processes on the wafer, so there is no assembly error of a triangular prism and a lens thereof, which improves structural accuracy of the aspheric prism.

The following describes the embodiments of the present disclosure in detail with reference to the accompanying drawings. However, it is appreciated by those skilled in the art that, in the embodiments of the present disclosure, many technical details are provided to enable a reader to better understand the present disclosure. However, even without these technical details and various changes and modifications based on the following embodiments, the technical solutions claimed in the present disclosure can be implemented.

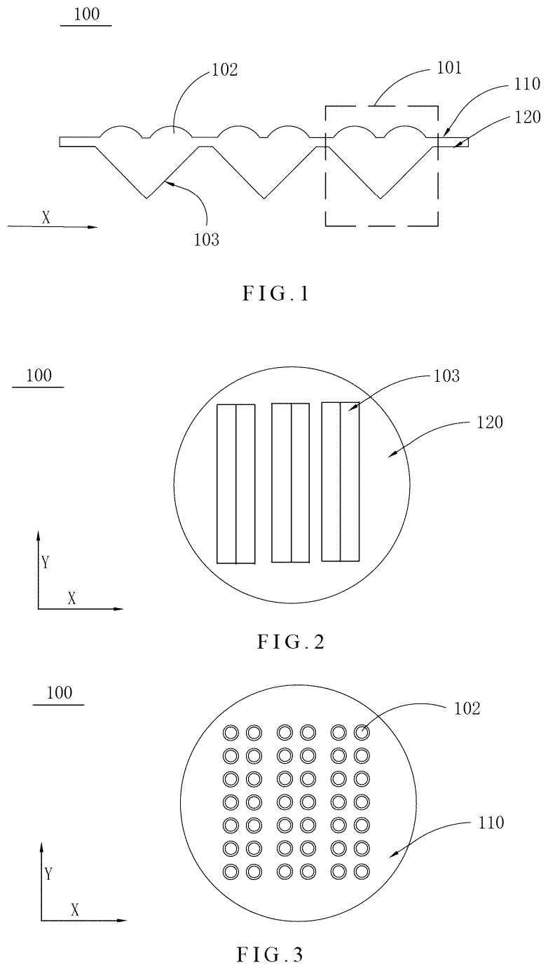

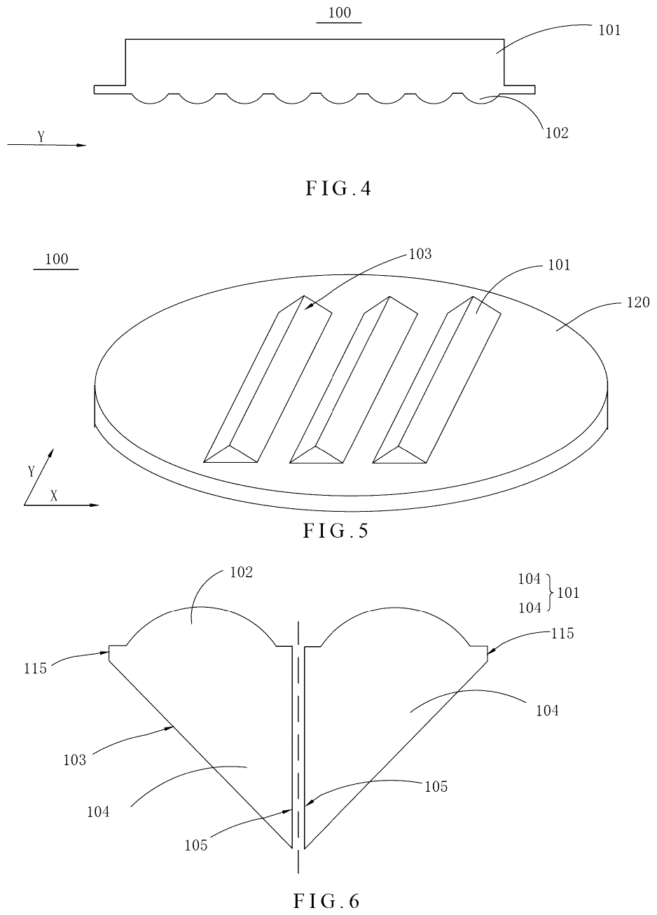

FIG. 1 is a front side schematic diagram of a wafer manufactured by an integrated molding process according to one embodiment of the present disclosure. FIG. 2 is a bottom plan schematic diagram of the wafer manufactured by the integrated molding process according to one embodiment of the present disclosure. FIG. 3 is a top plan schematic diagram of the wafer manufactured by the integrated molding process according to one embodiment of the present disclosure. FIG. 4 is a side elevational schematic diagram of the wafer manufactured by the integrated molding process according to one embodiment of the present disclosure. FIG. 5 is a perspective schematic diagram of the wafer manufactured by the integrated molding process according to one embodiment of the present disclosure.

It should be noted that FIGS. 1-5 illustrate a situation where the wafer comprises three first prism bars. However, the number of first prism bars on the wafer may be determined according to needs of actual applications. The embodiment of the present disclosure does not limit the number of the first prism bars disposed on the wafer.

As shown in FIGS. 1-5, the wafer 100 is formed by an integrated molding process. The wafer 100 comprises a first surface 110 and a second surface 120 opposite to the first surface 110. The wafer 100 comprises a first prism bars 101 arranged in sequence along a first direction X. Each of the first prism bars 101 comprises aspheric structures 102 protruded with respect to the first surface 110 of the wafer 100. The aspheric structures 102 thereof are arranged in two columns in the first direction X. The aspheric structures 102 in each of the columns are arranged in sequence along a second direction Y. Each of the first prism bars 101 further comprises two slopes 103 protruding with respect to the second surface 120 of the wafer 100. Each of the slopes 103 extends in the second direction Y.

In some embodiments, the integrated molding process is a hot press molding process. The hot press molding process refers to a processing method in which a pre-processed raw material is pressed and molded under high temperature and high pressure. The hot press molding process is suitable for manufacturing high-precision and high-strength products. In the hot press molding process, a plurality of processes are required, such as raw material pretreatment, hot pressing, cooling, grinding, etc. The plurality of processes are combined into one process, and the hot press molding process is able to improve production efficiency of the wafer.

In some embodiments, a precision tungsten steel mold is used for performing the hot pressing molding process, so that the wafer 100 formed therein has a sufficiently high precision. The hot pressing molding process is commonly performed at a sag temperature of a material of the wafer.

The material of the wafer 100 is optical glass, which has characteristics of high uniformity, no cracks, isotropy, good transmittance, high dispersion rate, and small temperature coefficient.

Each of the first prism bars 101 comprises two columns of the aspheric structures 102 arranged along the first direction X. Each of the aspheric structures 102 is served as a light-transmitting area of an incident surface of each aspheric prism to be manufactured later. Each of the aspheric structures 102 is equivalent to a lens in the aspheric prism of the related art. The lens is able to reduce an aberration of the aspheric prism and improve imaging quality.

Each of the first prism bars 101 further comprises the two slopes 103 protruding with respect to the second surface 120 of the wafer 100. Each of the slopes 103 is served as a reflection surface of each aspheric prism to be manufactured later.

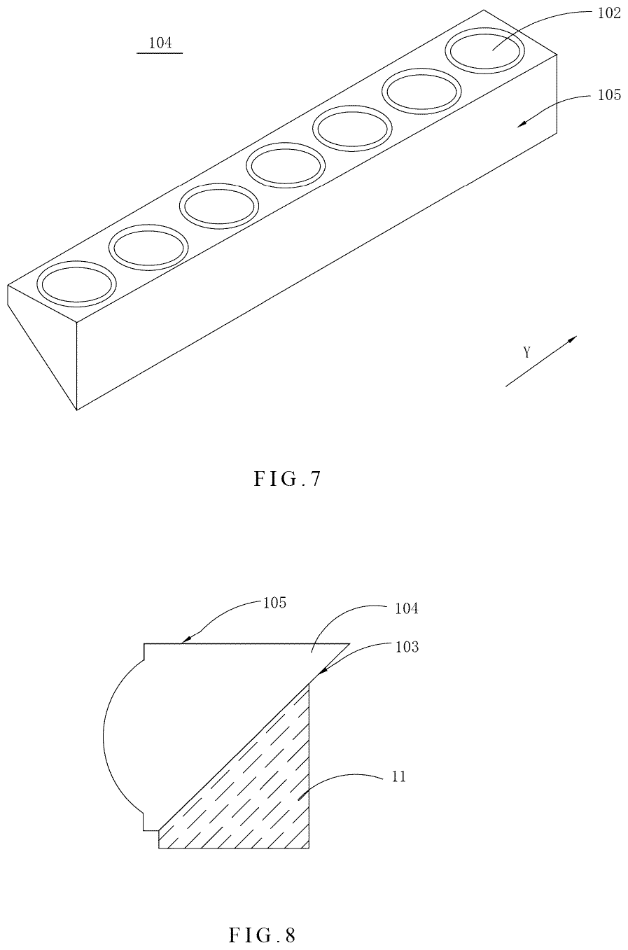

FIG. 6 is a structural schematic diagram of one of the first prism bars cutting into two second prism bars according to one embodiment of the present disclosure. FIG. 7 is a structural schematic diagram of one of the second prism bars according to one embodiment of the present disclosure. For ease of illustration, rest figures of the present disclosure take one of the second prism trips located on a left side of the dashed broken line shown in FIG. 6 as an example to illustrate subsequent processing of the second prism bars.

As shown in FIGS. 6-7, a first cutting process is performed on the wafer 100 to enable that the first prism bars 101 are separated from each other and each of the first prism bars 101 is cut into two second prism bars 104. Each of the second prism bars 104 comprises one slope of the slopes 103 and one column of the columns of the aspheric structures 102 arranged in sequence along the second direction Y. Cutting surfaces of the first prism bars 101 are configured as exit surfaces 105 of the second prism bars 104. The second prism bars 104 are formed by cutting the first prism bars 101 from the cutting surfaces. The cutting surfaces from which each of the first prism bars 101 is cut into the two second prism bars 104 thereof should be perpendicular to a surface where the aspheric structures 102 is located, so that during the first cutting process, each of the second prism bars 104 directly forms one exit surface 105 perpendicular to the surface where the aspheric structures 102 is located, which improves the manufacturing efficiency of the aspheric prism. In addition, during the first cutting process, cutting surfaces separating the first prism bars 10 from each other are defined as first chamfered surfaces 115.

The first cutting process may be laser cutting or water jet cutting, and during the first cutting process, it necessary to strictly monitor verticality and size data of the cutting surfaces (i.e., the exit surfaces 105 and the first chamfered surfaces 115).

In some embodiments, each of the first prism bars 101 is of an axisymmetric structure, and a cutting line of each of the first prism bars 101 cutting into the two second prism bars 104 thereof is a symmetry axis of each of the first prism bars 101.

By such arrangement, when the first prism bars 101 undergo the first cutting process, two identical second prism bars 104 are formed, thereby improving the utilization rate of the material of the wafer 100s, shortening the manufacturing cycle, and improving the manufacturing efficiency.

In other embodiments, each of the first prism bars is not an axisymmetric structure, so that the aspheric structures on the two second prism bars thereof formed by cutting each of the first prism bars are different, so that the wafer 100 formed by the integrated molding process is allowed to simultaneously produce two different specifications of aspheric prisms with a respective aspheric structure, and the manufacturing efficiency of the aspheric prisms is also improved.

FIG. 8 is a structural schematic diagram of the one of the second prism bars placed on a workbench according to one embodiment of the present disclosure.

As shown in FIGS. 7 and 8, in some embodiments, the one slope 103 of each of the second prism bars 104 is a flat surface. The one slope 103 of each of the second prism bars 104 is placed on the workbench 11, each of the exit surfaces 105 of the second prism bars 104 is ground and polished to enable that an included angle between each of the exit surfaces 105 of the second prism bars 104 and the one slope 103 of each of the second prism bars 104 is 45°.

In order to make the included angle between each of the exit surfaces 105 of the second prism bars 104 and the one slope 103 of each of the second prism bars 104 being 45°, each of the exit surfaces 105 of the second prism bars 104 needs to be ground first and then polished. Before grinding and polishing, the one slope 103 of each of the second prism bars 104 opposite to each of the exit surfaces 105 of the second prism bars 104 needs to be placed on the workbench 11, and the one slope 103 of each of the second prism bars 104 contacting the workbench 11 needs to be flat enough to ensure an attaching effect between the one slope 103 of each of the second prism bars 104 and the workbench 11. Each of the slopes 103 manufactured by the integrated molding process is the flat surface, and each of the slopes 103 is flat enough to ensure the attaching effect between each of the slopes 103 and the workbench 11, thereby avoiding movement of each of the second prism bars 104 caused by insufficient flatness of the one slope 105 thereof during a grinding process and a polishing process. Therefore, processing errors are avoided, which improves the reliability of grinding and polishing.

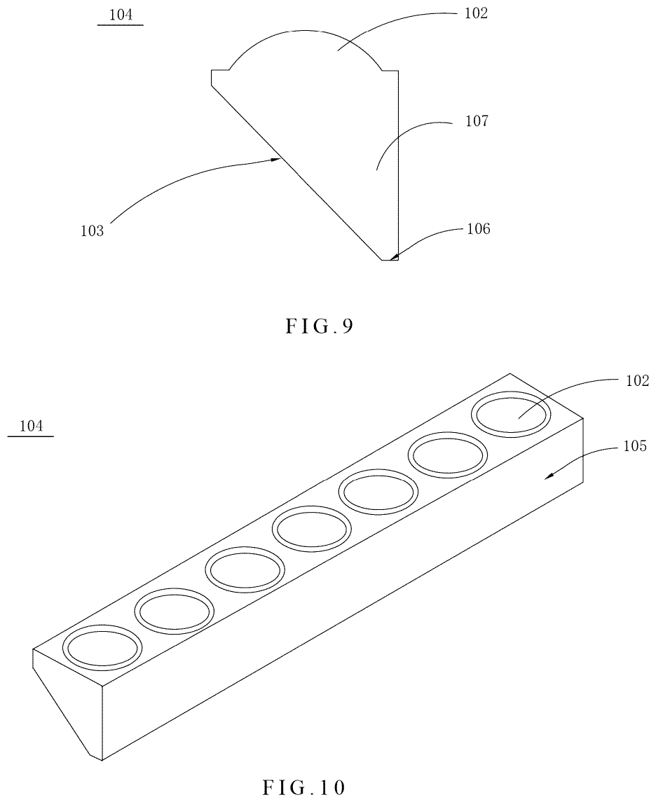

FIG. 9 is a front side schematic diagram of the one of the second prism bars after a chamfering process according to one embodiment of the present disclosure. FIG. 10 is a perspective schematic diagram of the one of the second prism bars after the chamfering process according to one embodiment of the present disclosure.

As shown in FIGS. 9-10, after polishing each of the exit surfaces 105 of the second prism bars 104, a corner of each of the second prism bars 104 is chamfered to form a second chamfered surface 106 of each of the second prism bars 104.

The corner of each of the second prism bars is chamfered to ensure that edges of each aspheric prism manufactured later are smooth and burr-free, thereby avoiding scratches or damage to other components when using each aspheric prism, which improves safety of each aspheric prism.

Specifically, a chamfering machine is provided for chamfering, and a size and edge breakage data of the second chamfered surface 106 of each of the second prism bars 104 are strictly monitored during chamfering.

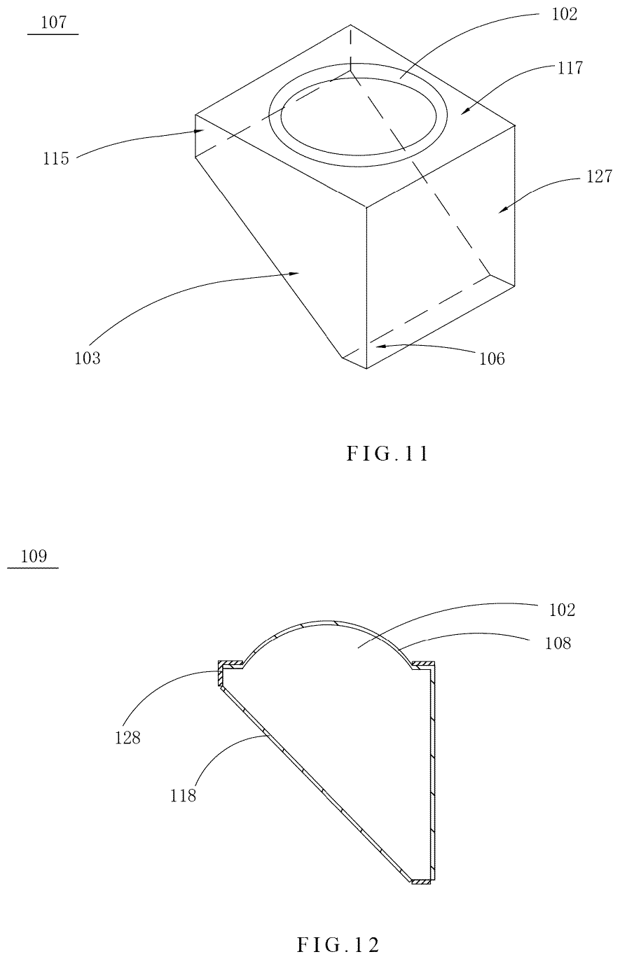

FIG. 11 is a perspective schematic diagram of an initial prism according to one embodiment of the present disclosure.

As shown in FIGS. 10-11, after the chamfering process, a second cutting process is performed on each of the second prism bars 104 to from initial prisms 107. A cutting line of each of the second prism bars 104 is located between adjacent aspheric structures 102, and each of the initial prisms 107 comprises a corresponding exit surface 105 and a corresponding slope 103.

The second cutting process may be the laser cutting or the water jet cutting, and during the second cutting process, it necessary to strictly monitor verticality and size data of cutting surfaces thereof.

Each of the initial prisms 107 after the second cutting process has a corresponding aspheric structure 102

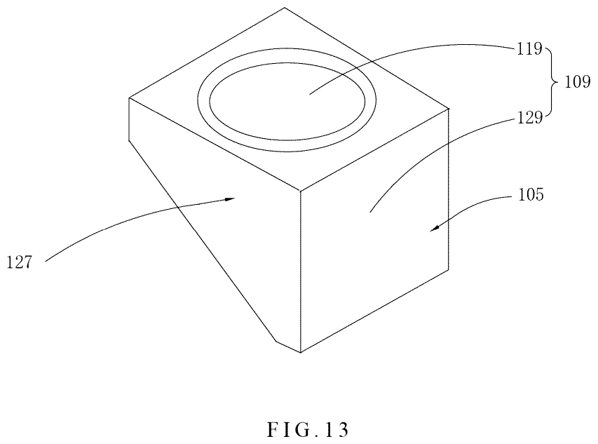

FIG. 12 is a side elevational schematic diagram of the aspheric prism according to one embodiment of the present disclosure. FIG. 13 is a structural elevational schematic diagram of the aspheric prism according to one embodiment of the present disclosure. It should be noted that for ease of illustration, an anti-reflection film, a high-reflection film and an ink layer of the aspheric prism are only shown in FIG. 12 and are not shown in FIG. 13.

As shown in FIGS. 11-13, an anti-reflection film 108 is formed on a surface where the corresponding aspheric structure 102 is located and the corresponding exit surface 105 of each of the initial prisms 107.

The surface where the corresponding aspheric structure 102 is located is an incident surface 117 of each of the initial prisms 107. The anti-reflection film 108 is formed on the incident surface 117 and the exit surface 105 of each of the initial prisms 107 to reduce a reflectivity of each aspheric prism, improve the imaging quality, and reduce glare and light loss.

In some embodiments, a refractive index of each of the initial prisms 107 is less than 1.75. The method further comprises forming a high reflection film 118 on the corresponding slope 103 of each of the initial prisms 107. Since the refractive index of each of the initial prisms 107 is relatively small, in order to improve the reflectivity of the corresponding slope 103 of each of the initial prisms 107, the high reflection film 118 is plated on the corresponding slope 103 of each of the initial prisms 107 to improve the reflectivity of the corresponding slope 103 configuring as the reflection surface.

In some embodiments, the refractive index of each of the initial prisms 107 is not less than 1.75. At this time, the refractive index of each of the initial prisms 107 is relatively large, which is sufficient to meet a reflectivity requirement of the reflection surface in each aspheric prism. There is no need to plate the high-reflection film on the corresponding slope 103 of each of the initial prisms 107, which saves manufacturing costs of each aspheric prism.

An ink coating operation is performed on surfaces other than the corresponding aspheric structure 102, the corresponding exit surface 105, and the corresponding slope 103 of each of the initial prisms 107 to obtain a corresponding aspheric prism 109 Specifically, the surface where the corresponding aspheric structure 102 is located is the incident surface 117, and each of the initial prisms 107 comprises one incident surface 117, one slope 103, one exit surface 105, one first chamfered surface 115, one second chamfered surface 106, and two side surfaces 127. The ink coating operation is performed on the one second chamfered surface 106, the two side surfaces 127, and a portion of the one incident surface 117 other than the one aspheric structure 102 thereof. When coating the ink, the one first chamfered surface 115 and the one second chamfered surface 106 of each of the initial prisms 107 are coated with the ink first, and then the portion of the one incident surface 117 other than the one aspheric structure 102 of each of the initial prisms 107 is coated with the ink, and finally the two side surfaces 127 of each of the initial prisms 107 are coated with the ink. The ink layer 128 formed by coating the ink reduces absorption of light at the edges of each aspheric prism, reduces a stray light coefficient of an optical system, and reduces unnecessary light reflection and scattering, thereby improving clarity and contrast of the imaging of each aspheric prism.

The integrated molding process is adopted to form the wafer having the aspheric structures. The aspheric structures in the wafer are equivalent to lenses, and then the first cutting process, the second cutting process is performed on the wafer then anti-reflection film is formed, and finally the aspheric prism is obtained. In the related art, it is necessary to form an initial triangular prism and an initial lens, and then the initial triangular prism and the initial lens are cut, coated, and inked to form a triangular prism and a lens, and then the triangular prism and the lens are assembled to form an aspheric prism in the related art. Compared with the related art, the method for manufacturing the aspheric prism of the present disclosure shortens a manufacturing cycle of the aspheric prism and improves the processing efficiency. The method of the present disclosure adopts the integrated molding process to directly form the wafer having the aspheric structures and the slopes, thereby reducing a grinding process for preparing aspheric structures and slopes in the related art, and thus further shortening the manufacturing cycle and improving the processing efficiency. In addition, each of the first prism bars in the wafer prepared by the integrated molding process comprises the two slopes thereof and the two columns of the aspheric structures thereof. When performing the first cutting process, each of the first prism bars is cut to form the two second prism bars thereof having the one slope and the one column of the column of the aspheric structures. Compared with a method of grinding the wafer directly in the related art to form second prism bars in the related art, the method of the present disclosure improves a utilization rate of a material of the wafer, shortens the manufacturing cycle, and improves the processing efficiency. Moreover, the wafer is formed by the integrated molding process, and the aspheric prism finally obtained is of an integrated structure by subsequent processing processes on the wafer, so there is no assembly error of a triangular prism and a lens thereof, which improves structural accuracy of each aspheric prism.

Correspondingly, another embodiment of the present disclosure further provides an aspheric prism prepared by the manufacturing method of the aspheric prism in the above embodiments. For parts that are the same or corresponding to the above embodiments, reference is made to the corresponding description of the above embodiments, which is not illustrated in details herein.

As shown in FIG. 12, each aspheric prism 109 comprises a lens 119 and a triangular prism 129.

It is understood by those skilled in the art that the above embodiments are specific examples for realizing the present disclosure, and in practical applications, various changes can be made to the above embodiments in form and details without departing from the spirit and scope of the present disclosure. Those skilled in the art can make various changes and modifications without departing from the spirit and scope of the present disclosure, so the protection scope of the present disclosure shall be subject to the scope defined in the claims.

What is claimed is:

1. A method for manufacturing an aspheric prism, comprising:
forming a wafer by an integrated molding process, wherein the wafer comprises a first surface and a second surface opposite to the first surface, the wafer comprises first prism bars arranged in sequence along a first direction, each of the first prism bars comprises aspheric structures protruded with respect to the first surface of the wafer, the aspheric structures thereof are arranged in two columns in the first direction, the aspheric structures in each of the columns are arranged in sequence along a second direction, each of the first prism bars further comprises two slopes protruding with respect to the second surface of the wafer, and each of the slopes extends in the second direction;
performing a first cutting process on the wafer to enable that the first prism bars are separated from each other and each of the first prism bars is cut into two second prism bars, wherein each of the second prism bars comprises one slope of the slopes and one column of the columns of the aspheric structures arranged in sequence along the second direction, cutting surfaces of the first prism bars are configured as exit surfaces of the second prism bars; the second prism bars are formed by cutting the first prism bars from the cutting surfaces;
performing a second cutting process on each of the second prism bars to from initial prisms, wherein a cutting line of each of the second prism bars is located between adjacent aspheric structures, and each of the initial prisms comprises a corresponding exit surface, a corresponding aspheric structure, and a corresponding slope;
forming an anti-reflection film on a surface where the corresponding aspheric structure is located and the corresponding exit surface of each of the initial prisms; and
performing an ink coating operation on surfaces other than the corresponding aspheric structure, the corresponding exit surface, and the corresponding slope of each of the initial prisms to obtain a corresponding aspheric prism.

2. The method according to claim 1, wherein the integrated molding process is a hot press molding process.

3. The method according to claim 1, wherein each of the first prism bars is of an axisymmetric structure, and a cutting line of each of the first prism bars cutting into the two second prism bars thereof is a symmetry axis of each of the first prism bars.

4. The method according to claim 1, wherein after performing the first cutting process, the method further comprises:
grinding and polishing each of the exit surfaces of the second prism bars to enable that an included angle between each of the exit surfaces of the second prism bars and the one slope of each of the second prism bars is 45°.

5. The method according to claim 4, wherein the one slope of each of the second prism bars is a flat surface.

6. The method according to claim 5, wherein before grinding each of the exit surfaces of the second prism bars, the method further comprises:
placing the one slope of each of the second prism bars on a workbench.

7. The method according to claim 4, wherein after polishing each of the exit surfaces of the second prism bars, the method further comprises:
chamfering a corner of each of the second prism bars to form a chamfered surface of each of the second prism bars.

8. The method according to claim 1, wherein a refractive index of a material of each of the initial prisms is not less than 1.75.

9. The method according to claim 1, wherein a refractive index of a material of each of the initial prisms is less than 1.75, and the method further comprises:
forming a high reflection film on the corresponding slope of each of the initial prisms.

10. An aspheric prism, wherein the aspheric prism is manufactured by the method according to claim 1.
